(19) United States
(12) Patent Application Publication
(10) Pub. No.: US 2025/0214072 A1
(43) Pub. Date: Jul. 3, 2025

(54) PLUGGED CERAMIC HONEYCOMB BODIES WITH PREFERENTIAL CATALYST LOADING AND METHODS OF MANUFACTURING THEREOF

(71) Applicant: CORNING INCORPORATED, CORNING, NY (US)

(72) Inventors: Hrushikesh Govindrao Pimpalgaonkar, Pune (IN); Kunal Upendra Sakekar, Pune (IN)

(21) Appl. No.: 19/083,662

(22) Filed: Mar. 19, 2025

Related U.S. Application Data
(62) Division of application No. 17/960,352, filed on Oct. 5, 2022.

(30) Foreign Application Priority Data
Oct. 8, 2021 (IN) 202111045934

(51) Int. Cl. B01J 35/56; B01D 46/24; B01D 53/94; B01J 35/64; B01J 37/00; B01J 37/02; B01J 37/08

(52) U.S. Cl. CPC B01J 35/56; B01D 46/24491; B01D 46/24492; B01D 53/9418; B01D 53/945; B01J 35/657; B01J 37/0018; B01J 37/0205; B01J 37/0207; B01J 37/08; B01D 2255/9155; B01D 2255/9202; B01D 2255/9205; B01D 2279/30

(57) ABSTRACT

A catalyst-coated, plugged honeycomb body having a honeycomb structure with a matrix of porous walls forming a plurality of channels, at least some of the plurality of channels being plugged to form inlet channels and outlet channels. At least some of the porous walls are filtration walls and at least some of the porous walls are non-filtration walls. A catalyst is preferentially disposed on the non-filtration walls, wherein the catalyst being preferentially disposed comprises CR<0.2 wherein CR is a coating ratio defined as an average percent loading of a washcoat containing the catalyst on and within the filtration walls divided by an average percent loading of the washcoat containing the catalyst on and within the non-filtration walls. Methods and apparatus configured to preferentially apply a catalyst-containing slurry to the non-filtration walls are provided, as are other aspects.

### CROSS REFERENCE TO RELATED APPLICATION

This application is a divisional of U.S. patent application Ser. No. 17/960,352 filed on Oct. 5, 2022, which claims the benefit of priority under 35 U.S.C § 119 of Indian Patent Application Serial No. 2021/11045934, filed on Oct. 8, 2021, the contents of which are relied upon and incorporated herein by reference in their entirety.

### FIELD

The present disclosure relates to catalyzed wall-flow filters comprising catalyst-coated, plugged honeycomb bodies useful in filtering particles from a fluid stream, such as from an engine exhaust stream.

### BACKGROUND

Wall-flow honeycomb filters may include a porous honeycomb body comprising a honeycomb wall structure with longitudinal, parallel channels defined by intersecting porous walls. The channels can be end-plugged, such as to form a pattern of plugs, such as a checkerboard pattern at inlet and outlet end faces, for example.

In operation, exhaust gas or other particulate-laden fluid flow enters the wall-flow honeycomb filter through inlet channels, is forced from inlet channels into outlet channels through the porous filtration walls, and exits through the outlet channels, with the porous filtration walls acting as filtration media entraining at least a portion of the particulates from the flow.

The porous honeycomb body may also be catalyzed to reduce pollutants such as sulphur oxides (SOₓ), nitrogen oxides (NOₓ), hydrocarbons, and/or carbon monoxide from the exhaust gas flow prior to the flow exiting the porous honeycomb body of the wall-flow particulate filter. In particular, in some porous honeycomb bodies, a catalyst can be applied as a component of a washcoat to the filtration walls.

### SUMMARY

In embodiments of the disclosure, a catalyst-coated, plugged honeycomb body is provided. The catalyst-coated, plugged honeycomb body, comprises a honeycomb structure comprising a matrix of porous walls forming a plurality of channels, at least some of the plurality of channels being plugged to form inlet channels opening at a first end of the honeycomb body and outlet channels open at a second end of the honeycomb body, wherein at least some of the porous walls are filtration walls that separate inlet channels from outlet channels and at least some of the porous walls are non-filtration walls; and wherein a catalyst is preferentially disposed in a washcoat on or in the non-filtration walls at a coating ratio CR<0.2, wherein the coating ratio CR is defined as a first average percent loading of the washcoat on and within the filtration walls divided by a second average percent loading of the washcoat on and within the non-filtration walls.

In embodiments, the coating ratio CR<0.15.

In embodiments, the coating ratio CR<0.10.

In embodiments, 0.0≤CR≤0.15.

In embodiments, the non-filtration walls separate adjacent outlet channels, extend into the outlet channels, or subdivide outlet channels.

In embodiments, the catalyst comprises a three way catalyst.

In embodiments, the catalyst comprises a selective catalyst reduction catalyst.

In embodiments, the inlet channels and filtration walls are substantially devoid of the catalyst.

In embodiments, a cross-sectional area of the outlet channels is greater than a cross-sectional area of inlet channels.

In embodiments, the porous walls have average bulk porosity in a range from 30% to 75%.

In embodiments, the porous walls have a median pore size from 5 μm to 30 μm.

In embodiments of the disclosure, a method of manufacturing a plugged and coated honeycomb body is provided. The method comprises subjecting outlet channels of the plugged honeycomb body to a sacrificial filler, wherein some of the porous walls that separate inlet channels from outlet channels are filtration walls and at least some of the porous walls are non-filtration walls, and wherein the sacrificial filler at least partially fills some of the filtration walls; subjecting the outlet channels to a catalyst-containing slurry to form a filled and catalyst coated body by depositing particles of the catalyst-containing slurry on or in the non-filtration walls; and removing the sacrificial filler to preferentially load catalyst on or in the non-filtration walls.

In embodiments, the catalyst is preferentially loaded on the non-filtration walls to result in a coating ratio CR<0.2, wherein the coating ratio CR is defined as an average percent loading of a washcoat containing the catalyst on and within the filtration walls divided by an average percent loading of the washcoat containing the catalyst on and within the non-filtration walls.

In embodiments of the disclosure, a method of catalyst coating a plugged honeycomb body is provided. The method comprising subjecting the outlet channels, filtration walls separating the outlet channels from the inlet channels, and non-filtration walls located within the outlet channels, to a sacrificial filler wherein the sacrificial filler preferentially fills the filtration walls; and subjecting the outlet channels and the non-filtration walls to a catalyst-containing slurry wherein the sacrificial filler in the filtration walls causes preferential loading of the catalyst-containing slurry on the non-filtration walls.

In embodiments, the method comprises calcining to burn off the sacrificial filler.

In embodiments, the calcining is conducted at 600° C. or more.

In embodiments, the sacrificial filler comprises carbonaceous soot.

In embodiments, the sacrificial filler has an average particle size that is less than a median pore size of a porosity of the filtration walls.

In embodiments, the sacrificial filler has an average particle size that from 0.005 μm to 300 μm, and the median pore size of the porosity of the filtration walls is from 5 μm to 30 μm.

In embodiments, comprising monitoring backpressure as the sacrificial filler is provided to the outlet channels to gauge a degree of fill of the filtration walls with the sacrificial filler.

Numerous other features and aspects are provided in accordance with the embodiments of the disclosure. Further features and aspects of embodiments will become more fully apparent from the following detailed description, the claims, and the accompanying drawings.

### BRIEF DESCRIPTION OF THE DRAWINGS

The accompanying drawings are included to provide a further understanding of the disclosure and are incorporated in and constitute a part of this specification, illustrate embodiments of the disclosure, and together with the description serve to explain the disclosure.

FIG. 1 schematically illustrates a perspective view of a plugged porous honeycomb body with preferential catalyst loading according to one or more embodiments of the disclosure.

FIG. 2 schematically illustrates a plan view showing an inlet end face of the plugged porous honeycomb body shown in FIG. 1.

FIG. 3 schematically illustrates a plan view showing an outlet end face of the plugged porous honeycomb body shown in FIG. 1.

FIG. 4 schematically illustrates a cross-sectional side view showing a cross-section of a preferentially catalyst coated plugged porous honeycomb body taken along section line 4-4 of FIG. 3.

FIG. 5A schematically illustrates a side plan view of a loading apparatus configured to preferentially fill the filtration walls of a plugged porous honeycomb body with a sacrificial filler according to one or more embodiments.

FIG. 5B schematically illustrates a cross-sectioned side view of a plugged porous honeycomb body mounted in a receptacle of a loading apparatus configured to preferentially load the filtration walls with a sacrificial filler according to one or more embodiments.

FIGS. 6A and 6B schematically illustrate a side plan view of a slurry coating apparatus configured to preferentially coat a catalyst-containing slurry on the non-filtration walls of a plugged porous honeycomb body according to one or more embodiments.

FIG. 7 illustrates a flowchart of a method of preferentially catalyst coating of non-filtration walls of a plugged porous honeycomb body according to one or more embodiments.

FIGS. 8-27 schematically illustrate cross-sectioned partial views showing various configurations of preferentially coated non-filtration walls of a portion of a repeatable unit cell of a plugged porous honeycomb body according to the disclosure.

### DETAILED DESCRIPTION

Ceramic honeycomb bodies used in the treatment of fluid streams may comprise a catalyst-containing washcoat, such as a selective catalyst reduction (SCR) catalyst or other catalyst contained within a washcoat. For example, washcoat containing the catalyst may be disposed as a washcoat across the porous filtration walls of the honeycomb body or deposited within the pores of the porous filtration walls of either or both of the inlet channels and outlet channels. Channels having their ends plugged at the inlet end face and open at the outlet end face are referred to as “outlet channels” herein, and the channels having their ends plugged at the outlet end face and open at the inlet end face are referred to as “inlet channels” herein.

When catalyst is provided as a washcoat to the inlet channels of a filter, the effective flow area of the inlet channels may be decreased as the thickness of the washcoat on the filtration walls is increased thus reducing open frontal area (OFA). The resulting decrease in effective flow area and decreased open frontal area (OFA) may result in an increase in pressure drop across such coated ceramic honeycomb bodies, with an undesirable corresponding increase in system backpressure.

When the catalyst-containing washcoat is deposited within the pores of the porous filtration walls of a filter, the effective flow area of the inlet channels may still be reduced, but to a lesser amount, due to high catalyst loads needed to provide the suitable reduction in NOx, such as when using an SCR catalyst. However, as the catalyst load within the pores of the filtration walls increases, the soot and ash storage capacity of the porous honeycomb body decreases since pores that would otherwise be available for collecting soot and ash particles may now be at least partially filled with the catalyst containing washcoat.

Thus, in accordance with embodiments described herein, preferentially-coated, plugged porous honeycomb bodies are provided, such as for use with an SCR catalyst-containing washcoat or other catalyst-containing washcoat. Further, methods of preferentially coating non-filtration walls of such plugged, porous honeycomb bodies are provided.

The catalyst-coated, plugged porous honeycomb bodies can comprise outlet channels and inlet channels. The inlet channels and outlet channels comprise porous walls. Some of the porous walls of the catalyst coated-ceramic, plugged honeycomb body comprise filtration walls (e.g., walls of each inlet channel through which a flow of fluid must flow in order to exit the plugged honeycomb body) and some of the porous walls comprise non-filtration walls (e.g., walls that are located in the outlet channels, or not located in the inlet channels, or otherwise through which the flow of fluid does not need to flow in order to exit the plugged honeycomb body). In embodiments, the filtration walls operate to separate inlet channels from outlet channels. The non-filtration walls can separate adjacent outlet channels, subdivide the outlet channels, or extend into the outlet channels (like fins). According to embodiments, a catalyst (e.g., an SCR catalyst-containing washcoat or other catalyst-containing washcoat) is applied preferentially to and disposed on non-filtration walls in the outlet channels, thus leaving a larger portion of filtration walls of the inlet channels with relatively lower amounts of catalyst-containing washcoat and thus the filtration walls are more free to capture particulates within the particulate filter, reducing backpressure, and improving passive regeneration of soot captured in the inlet channels and filtration walls.

In embodiments, the plugged porous honeycomb bodies may include inlet channels and outlet channels, wherein the outlet channels can have a greater total surface area than the total surface area of inlet channels. For example, the plugged porous honeycomb bodies can comprise a matrix of intersecting porous walls forming a plurality of axially extending channels, wherein at least some of the plurality of axially extending channels are plugged to form inlet channels and outlet channels. The SCR catalyst or other catalyst is preferentially located within the outlet channels and is preferentially disposed on the non-filtration walls thereof. The SCR catalyst or other catalyst may be applied as a homogeneous component of a washcoat. In some embodiments, the washcoat is preferentially applied across the walls of the outlet channels and selectively applied within the pores of the non-filtration walls of the outlet channels, thus the percentage of loading of catalysts-containing washcoat, by weight, is higher on the non-filtration walls than on the filtration walls.

In embodiments, the non-filtration walls that are located solely within the outlet channels and enable the outlet channels to comprise a higher total surface area than the inlet channels. In such an embodiment, the catalyst (e.g., SCR or other catalyst) may be applied and provided preferentially to the non-filtration walls within the outlet channels. The term “preferentially” as used herein means that within any outlet channel, the non-filtration walls have relatively more catalysts-containing washcoat (on average), and thus relatively more SCR catalyst or other catalyst, applied thereto as compared to the filtration walls. The relative reduction of catalyst-laden washcoat in the filtration walls can reduce a pressure drop across the filtration walls and the preferential location of the SCR or other catalyst on the non-filtration walls within the outlet channels may improve passive regeneration capability of soot while also increasing catalytic efficiency, such as for NOx.

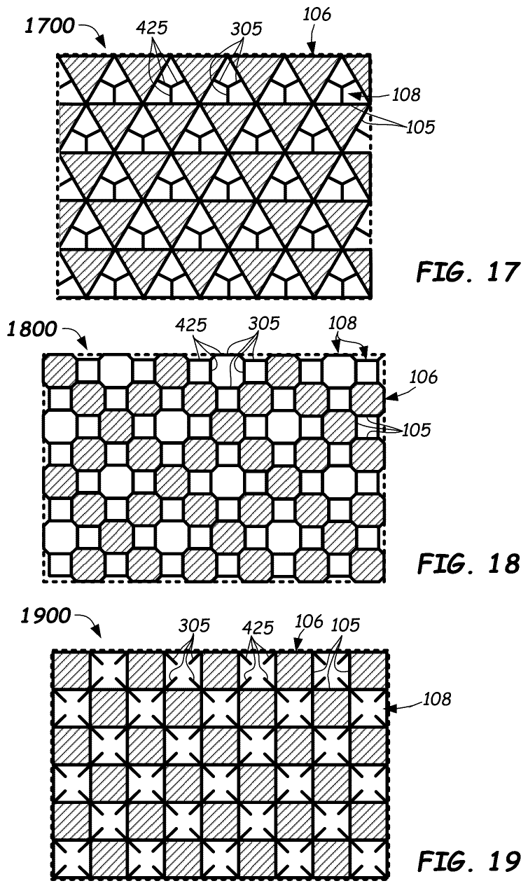

In embodiments, the coated ceramic honeycomb body can comprise inlet channels and outlet channels, which are similarly sized and shaped, but wherein there are more outlet channels than inlet channels. For example, the walls can define a square-shaped pattern extending across a cross-section of both the inlet channels and the outlet channels. Alternatively, the inlet channels can be shaped differently than the outlet channels. In some embodiments, the walls define a square-shaped pattern extending across a cross-section of the outlet channels and a square-shaped pattern extending across a cross-section of the inlet channels (FIGS. 2-3, 8, 12, and 19-25), wherein the total surface area of the outlet channels is greater than the total surface area of the inlet channels. As another example, the walls define a rectangular-shaped pattern extending across a cross-section of the inlet channels and a square-shaped pattern extending across a cross-section of the outlet channels (FIG. 11). As yet another example, the walls define a triangular-shaped pattern extending across a cross-section of the inlet channels and a cross-section of the outlet channels (FIG. 17), but wherein the outlet channels are subdivided by non-filtration walls to provide greater surface area than inlet channels. Other variations are described herein. These various configurations of walls across the inlet and outlet channels may provide for increased isostatic strength and allow for preferential loading of washcoat on non-filtration walls.

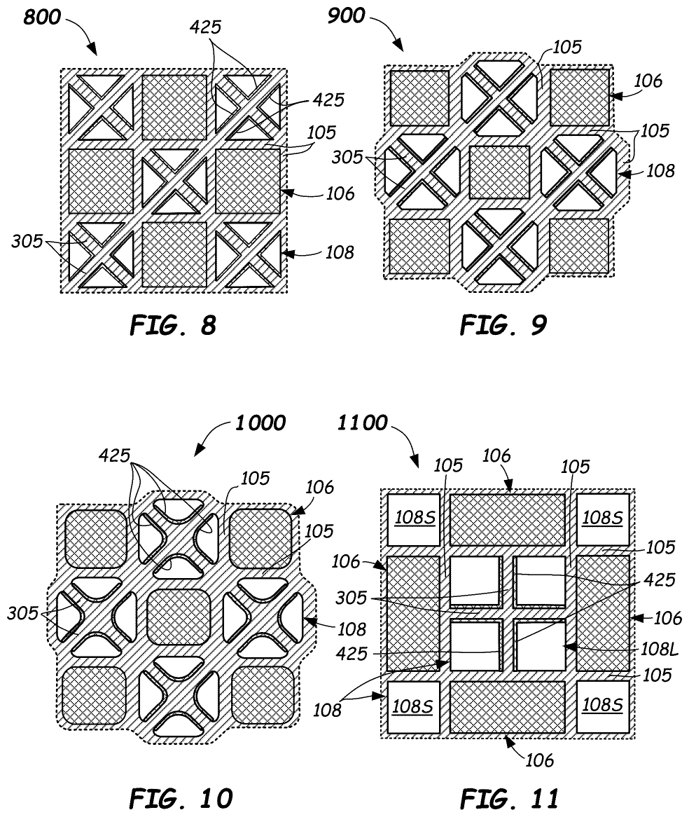

In embodiments, the coated-ceramic honeycomb body comprises non-filtration walls within the outlet channels that are arranged in various different configurations. For example, the non-filtration walls can connect to opposing corners of the filtration walls defining portions of the outlet channels, such as in an x-shaped configuration (FIGS. 8 and 10). In another example, the non-filtration walls connect across different opposing midpoints of at least some of the filtration walls defining at least some of the outlet channels in a cross-shaped or Y- or T-shaped configuration (FIGS. 2, 3, 10, 11, 17, 20, and 23). In yet another example, the non-filtration walls connect across different opposing midpoints of the filtration walls or non-filtration walls defining at least some of the outlet channels (FIGS. 9, 14-16, 27). In yet another example, the non-filtration walls connect to one or more corners or sides and extend into the outlet channels (FIGS. 19, 20, 22, 24-26). The presence of non-filtration walls within the outlet channels in various configurations may provide for a further increase in isostatic strength as well as more area for application of catalyst-containing washcoat (e.g., SCR catalyst containing or other catalyst-containing washcoat).

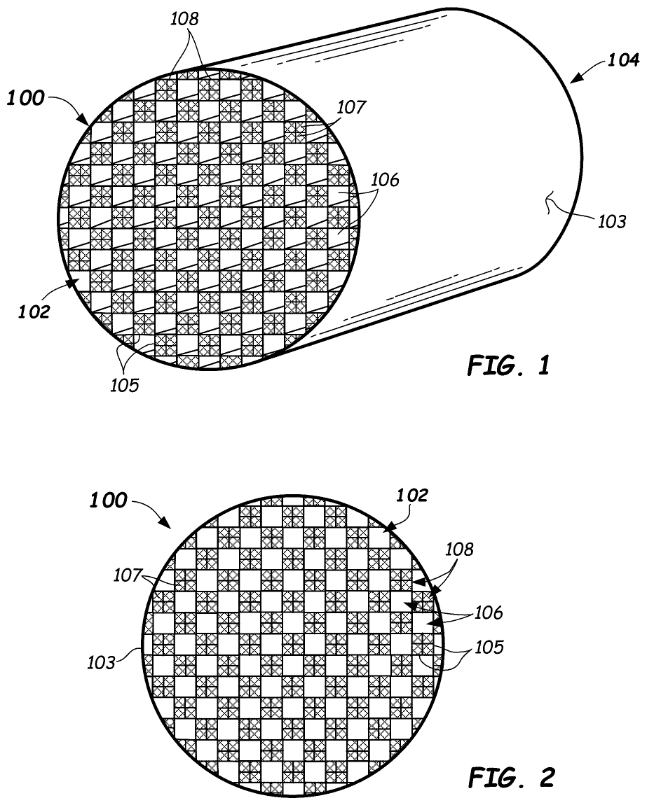

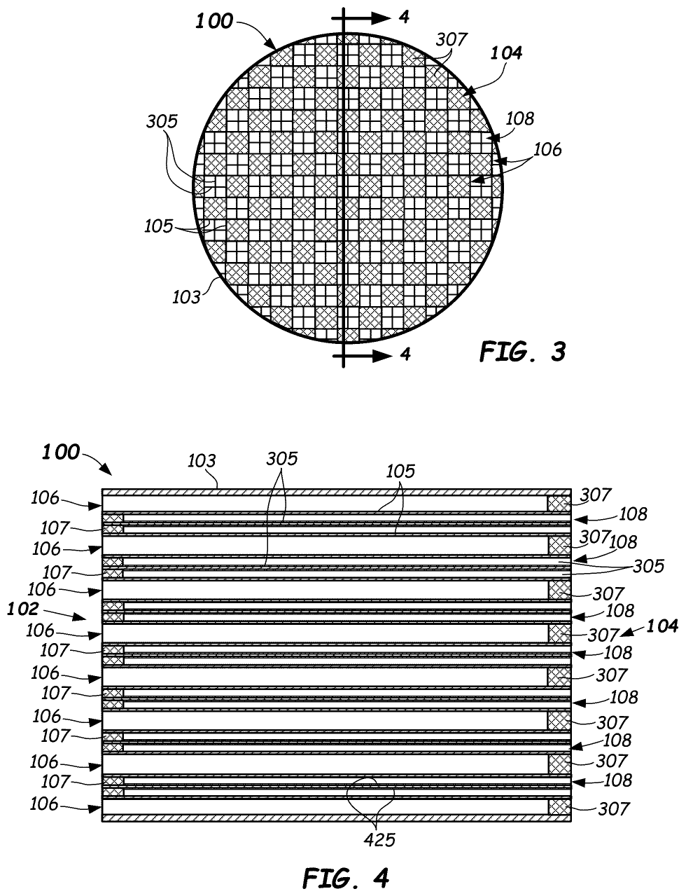

FIG. 1 is a perspective view of a porous ceramic honeycomb body comprising plugs according to one or more embodiments. The ceramic honeycomb body 100 comprises an inlet face 102 (FIG. 2) and an outlet face 104 (FIG. 3) on an opposite end thereof. The honeycomb structure of the porous ceramic honeycomb body 100 comprises a plurality of parallel inlet channels 106 and outlet channels 108 defined at least in part by porous filtration walls 105. Porous filtration walls 105 can contain average bulk porosity (porosity or % P) of from 30% to 75%, for example. The porosity can be designed to contain a median pore diameter of from 5 μm and 30 μm, for example. A skin 103 can be formed about a periphery of the filtration walls 105 and the honeycomb structure. Skin 103 can be extruded or after-applied (applied after extrusion or firing). The outlet channels 108 can be plugged with plugs 107 in a pattern (e.g., a checkerboard pattern as shown or other pattern) at the inlet face 102 (FIG. 2) of the honeycomb body 100 in some embodiments. Similarly, the inlet channels 106 can be plugged with plugs 307 in a pattern (e.g., a checkerboard or other pattern) at the outlet face 104 of the honeycomb body 100. Other plugging patterns are possible, and all channels are plugged in some embodiments. It should be understood, however, that some channels may be unplugged channels such as in a partial filter application.

FIG. 2 is an inlet end plan view schematically showing an inlet face 102 of the coated ceramic honeycomb body 100 shown in FIG. 1. As discussed above, the outlet channels 108 are plugged on the inlet face 102 of the honeycomb body 100. As a result, in use, a particulate-laden flow can enter the porous honeycomb body 100 through the inlet channels 106, which are open on the inlet face 102 of the honeycomb body 100. The inlet channels 106 and the outlet channel 108 are separated by porous filtration walls 105.

FIG. 3 is an outlet end plan view schematically showing an outlet face 104 of the coated ceramic honeycomb body 100 shown in FIG. 1. As discussed above, the inlet channels 108 are plugged with plugs 307 on the outlet face 104 of the porous honeycomb body 100. As a result, a gas flow that enters the porous honeycomb body 100 through inlet channels 106 on the inlet face 102 passes through the filtration walls 105 and into outlet channels 108 and exits at the outlet face 104 of the porous honeycomb body 100. As the particulate-laden gas flow passes through the filtration walls 105, particles are trapped on or within the filtration walls 105 and can be removed from the gas flow at relatively high filtration efficiency (e.g., >99%).

In FIG. 2, the filtration walls 105 are shown as defining a square-shaped pattern extending across a cross-section of the inlet channels 106 and defining a square-shaped pattern across a cross-section of the outlet channels 108. Additional configurations of the filtration wall 105 can be implemented across the inlet channels 106 and the outlet channels 108, such as those shown herein. Optionally, the filtration walls 105 can be arranged to provide inlet channels and outlet channels of other polygonal shapes in transverse cross-section.

The outlet channels 108 at least partially defined by the filtration walls 105 can comprise non-filtration walls 305 which, in the depicted embodiment, subdivide output channels 108 into subchannels. The non-filtration walls 305 increase a total surface area of the outlet channels 108 such that the total surface area of the outlet channels 108 is greater than the total surface area of the inlet channels 106 for the coated ceramic honeycomb body 100.

In some embodiments, the ratio of total surface area of the outlet channels 108 to the total surface area of the inlet channels 106 can range from 1.2 to 4.0. In further embodiments, the ratio of the total surface area of the outlet channels 108 is 2.0 or more times greater than the total surface area of the inlet channels 106. Moreover, in some embodiments, the ratio of the total surface area of the outlet channels 108 to the total surface area of the inlet channels 106 can range from 2.0 to 3.0.

A catalyst, such as an SCR or other catalyst can be applied preferentially to the non-filtration walls 305 thereby helping to reduce the pressure drop across the filtration walls 105, by minimizing the washcoat loading (and catalyst loading—e.g., SCR or other catalyst loading) on the filtration walls 105. The catalyst can be applied as a component of a washcoat 425 across the surfaces of the non-filtration walls 305, deposited within the pores of the non-filtration walls 305, or both.

In FIG. 3, the non-filtration walls 305 are shown as connecting across different opposing midpoints of the filtration walls 105 defining non-filtration walls 305 in the outlet channels 108 in a cross-shaped configuration in the depicted orientation. Additional non-filtration wall 305 configurations may be implemented within the outlet channels 108 as are shown and contemplated herein.

FIG. 4 is cross-sectional side view schematically showing a cross-section taken along section line 4-4 of FIG. 3. The inlet face 102 comprises a plug 107 at each of the outlet channels 108 in the embodiment shown. Similarly, the outlet face 104 comprises a plug 307 at each of the inlet channels 106. The inlet channels 106 and the outlet channels 108 can, as shown, be separated by porous filtration walls 105. The filtration walls 105 filter particles in a particulate-laden flow as it passes from an inlet channel 106 to an outlet channel 108. Once the flow has passed through the filtration walls 105, leaving behind a large percentage of the soot and other particles, and has entered the outlet channels 108, the flow then interacts via a catalyzing reaction with the catalyst-containing washcoat 425 (e.g., a SCR catalyst-containing washcoat) preferentially coated in the outlet channels 108 and preferentially loaded on the non-filtration walls 305. The phrase “preferentially loaded on the non-filtration walls” as used herein means loaded on an outside surface of the non-filtration wall 305 or on surfaces of pores within the non-filtration wall 305, or both. The phrase “preferentially loaded” further means that the catalyst-containing washcoat 425 has more washcoat loading, by weight, on average, carried by the non-filtration walls 305 than by the filtration walls 105. Notably, some smaller amount of catalyst-containing washcoat 425 may still remain carried by the filtration walls 105, but to a lesser extent by weight on average than on the non-filtration walls 305. Thus, as described herein backpressure through the filtration walls 105 can be advantageously lowered or the wall thickness can be advantageously increased for strength at the same backpressure.

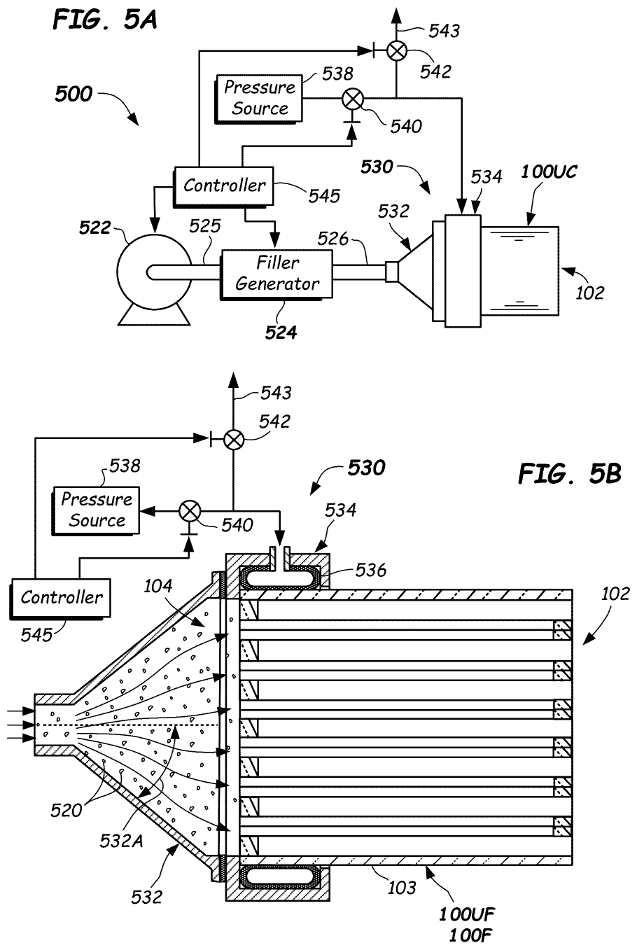

FIGS. 5A and 5B schematically illustrate a schematic side view of an apparatus 500 (FIG. 5A) as well as a cross-sectioned side view of a coupling member 530 in FIG. 5B operatively used to at least partially fill the outlet channels 108 and filtration walls 105 with a sacrificial filler 520 (FIG. 5B) according to one or more embodiments. In particular, any suitable method and apparatus for subjecting the outlet channels 104 to a sacrificial filler 520 can be used wherein the sacrificial filler 520 at least partially fills some of the filtration walls 105.

As shown, one example of a filler apparatus 500 comprises a blower 522 configured to provide a pressurized gas to a filler generator 524 in conduit 525. Filler generator 524 can be any apparatus that can produce a fine sacrificial filler 520, such as carbon-containing soot. The sacrificial filler 520 can be generated as particles that can have a range of median particle diameter of from 0.005 μm to 300 μm, for example. For example, soot can be generated as a result of incomplete combustion. To achieve incomplete combustion instead of complete combustion, a fuel can, for example, burn in a suitable burner at a lower temperature and with a slightly reduced supply of oxygen. When the fuel burns, it breaks into small particles that include soot. The gas flow from blower 522 can entrain the generated sacrificial filler 520 (e.g., soot particles) and carries them through optional conduit 526 to coupling member 530 having a plugged unfilled honeycomb body 100UF mounted therein. As shown, the plugged unfilled honeycomb body 100UF is mounted to the coupling member 530 with the outlet face 104 facing upstream to the flow of sacrificial filler 520.

The coupling member 530 can comprise a flow expander 532 to transition the flow more evenly to the outlet end face 104 of the plugged unfilled honeycomb body 100UF. Flow expander 532 can comprise an expansion angle 532A that expands gradually, such as comprising an expansion ratio ER≥3.0, wherein ER=ΔL/ΔR, and wherein ΔL is a change in length L and ΔR is a corresponding change in radius R. Thus, the expansion angle should be less than or equal to 18.4 degrees, or even less than or equal to 11.3 degrees (corresponding to ER≥5.0). Coupling member 530 can further comprise a sealing member 534 configured to seal about a periphery of the plugged unfilled honeycomb body 100UF, such as to skin 103. Sealing member 534 may comprise a bladder 536 encircling the plugged unfilled honeycomb body 100UF that is expandable and deflatable. The expansion for sealing is subject to a pressurized gas being provided from pressure source 538 while opening of a supply valve 540 and closing an exhaust valve 542. Deflation of the bladder 536 can be subject to exhausting the pressurized gas in bladder 536 by closing supply valve 540 and opening exhaust valve 542 to discharge gas to an exhaust 543. Other suitable mechanisms or apparatus to seal around the perimeter of the plugged unfilled honeycomb body 100UF may be used. Control of the supply valve 540 and exhaust valve 542 may be by way of a controller 545. Controller 545 may also control operation of the blower 522 and the filler generator 524. Operation of the filler apparatus 500 fills the outlet channels 108 and at least some of the filtration walls 105 with sacrificial filler 520 to produce a filled honeycomb body 100F. The filtration walls 105 may have porosity at least partially filled with the sacrificial filler 520. The sacrificial filler 520 may also be disposed on the filtration walls 105.

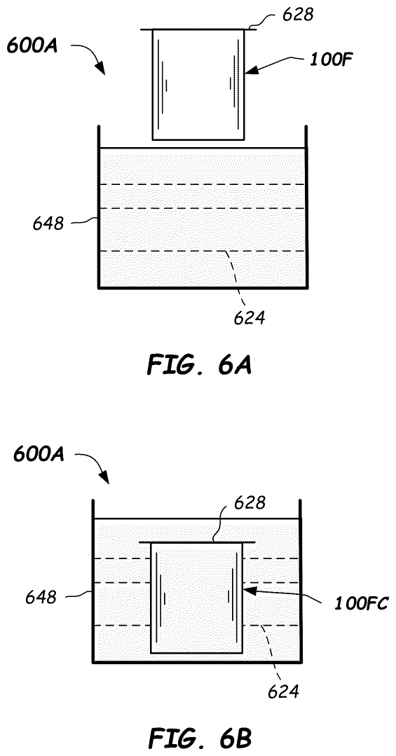

FIGS. 6A and 6B schematically illustrate schematic side views of a slurry coating apparatus 600A that can be used to apply a catalyst-containing coating (e.g., a catalyst-containing slurry 624) to the outlet channels 108 and non-filtration walls 305 of the filled honeycomb body 100F provided after filling with sacrificial filler 520 according to embodiments. Thus, the outlet channels 108 and the non-filtration walls 305 can be subjected to a catalyst-containing slurry wherein the preferential loading of the filtration walls 105 with the sacrificial filler 520 causes preferential loading of the catalyst-containing slurry 624 on the non-filtration walls 305 and forms a preferentially washcoated body embodied as a filled and coated honeycomb body 100FC. Because there is no appreciable pressure across the non-filtration walls 305 during the filling with the sacrificial soot 520, the non-filtration walls 305 do not have any appreciable sacrificial filler 520 disposed thereon. Thus, the non-filtration walls 305 are in a condition to better accept the washcoat therein and thereon, as compared to the filtration walls 105.

In particular, the filled honeycomb body 100F can be dipped in a reservoir 648 containing a catalyst-containing slurry 624 as is shown in FIG. 6B. In some embodiments, a sealing member 628 may be applied to the area of the skin 103 and/or to the inlet end face 102 so that no catalyst-containing coating 624 is applied thereto or therein, respectively. Sealing member 628 may be polymer film including a pressure sensitive adhesive thereon. The addition of the Sealing member 628 on the inlet end face 102 can allow the filled honeycomb body 100F to be rotated and manipulated within the reservoir 648 to aid in fully coating the outlet channels 108 and the non-filtration walls 305.

The catalyst-containing washcoat 624 can be made from alumina or other suitable inorganic particulates disbursed in a liquid (e.g., water) along with a suitable catalyst material for the desired reaction. The catalyst can be an SCR catalyst that can “selectively” convert NOx into nitrogen and water, thereby substantially reducing NOx emissions (e.g., by up to 97%), for example. For SOx removal, the catalyst used can be a platinum group metal component that is selected from the group consisting of palladium, rhodium, ruthenium, iridium, and combinations thereof, for example. Other materials such as oxides and aluminum oxides of lithium, magnesium, calcium, manganese, iron, cobalt, nickel, copper, zinc, and silver can be included as part of the catalyst-containing slurry 624. In some embodiments, the catalyst can be a SOₓ sorbent component selected from the group consisting of MgO and MnO₂, for example. The washcoat loading of washcoat on the non-filtration walls 305 after calcining, when using an SCR catalyst, can be from 20 g/L to about 250 g/L on the non-filtration walls 305. Depending on the type of catalyst, other washcoat loadings can be used. The proper washcoat loading on the no-filtration walls 305, by weight, can be determined by testing of the catalyst-containing washcoat on the particular design (e.g., wall thickness, cell density, porosity, median pore size, and non-filtration wall design) and size of the coated honeycomb body 100 while be subjected to expected amounts of effluent to be abated.

Once initially coated, the filled and coated honeycomb body 100FC can be dried at from 50° C. to 150° C., for example for a sufficient time to dry the catalyst-containing washcoat 624 applied to the filled honeycomb body 100F. Multiple dipping and drying sequences can be undertaken to achieve a desired weight loading of the catalyst-containing washcoat 624. In some embodiments, dipping and coating with the catalyst-containing washcoat 624 followed by drying can continue until a desired pre-firing washcoat loading is achieved.

Following coating and drying of the filled honeycomb body 100F to produce the filled and coated honeycomb body 100FC, the sacrificial filler is removed from the filled and coated honeycomb body 100FC. For example, the filled and coated honeycomb body 100FC can be heated to a sufficient calcining temperature to burn out the sacrificial filler 520 and also to calcine the catalyst-containing washcoat 624. The calcining temperature may be from 300° C. to 1,000° C. for from 30 minutes to 5 hours, depending on the size of the filled honeycomb body 100F. In other embodiments, the sacrificial filler can be removed by another treatment, such as a physical treatment and/or chemical treatment, e.g., blowing an airflow through the honeycomb body to blow the sacrificial filter out of the body, or exposing the filled and coated honeycomb body to a solvent or chemical agent that acts to remove the sacrificial filler.

In some embodiments, an amount of catalyst-containing washcoat loading, after calcining, can be greater on the non-filtration walls 305 than on the filtration walls 105, i.e., the calcined washcoat is preferentially loaded on the non-filtration walls 305. Washcoat loading on the non-filtration walls 305 can be any suitable amount measured on a representative portion of the non-filtration walls 305 of the porous honeycomb body 100 after calcining to achieve a desired abatement goal.

In the embodiment of FIG. 6A and 6B, following the filling operation by subjecting the outlet channels 108 and the non-filtration walls to the sacrificial filler, and after an amount of the catalyst-containing slurry 624 has been subjected to the outlet channels and non-filtration walls 305 preferential washcoat loading is provided in the filled and coated honeycomb body 100FC. This is true after washcoating and both before and after calcining, because there is no pressure differential when applying the sacrificial filler 520, a larger extent of the porosity in the filtration walls 105 is filled with the sacrificial filler 520 that the non-filtration walls 305. Thus, more porosity is available in the non-filtration walls for accepting washcoat 624.

In some embodiments the relative washcoat loading (defining an extent of preferential washcoat loading after calcining) as between the filtration walls 105 and the non-filtration walls 305 can be expressed by Eqn. 1 as a coating ratio (CR):

CR=WLf/WLnf Eq. 1

wherein
WLf is an average washcoat loading, by weight, on and within the filtration walls 105 in g/L, and
WLnf is an average washcoat loading, by weight, on and within the non-filtration walls 305 in g/L.

According to embodiments, the coating ratio CR can be less than 0.2, less than 0.15, or even less than 0.10 for example. Thus, the present method comprising pre-filling the filtration walls with sacrificial filler 520 lowers the coating ratio CR and substantially reduces the amount of catalyst containing washcoat in the pores of the filtration walls 105, thus substantially decreasing backpressure across the filtration walls 105. Total elimination of washcoat from the pore structure of the filtration walls 105 is desirable in some embodiments (e.g., to assist in minimizing the backpressure penalty after washcoating), but even in such embodiments, at least trace amounts of the catalyst may be present.

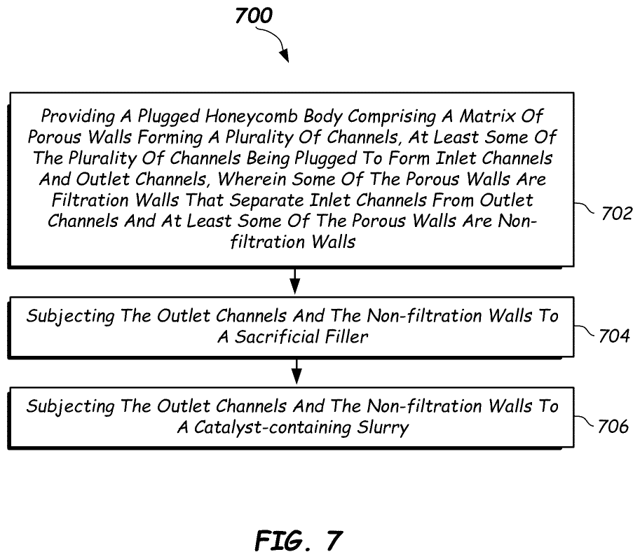

FIG. 7 illustrates a flowchart of a first method of catalyst coating of a plugged honeycomb body (e.g., plugged and unfilled honeycomb body 100UF) according to one or more embodiments herein. The method 700 comprises, in block 702, providing a plugged honeycomb body (e.g., plugged and unfilled honeycomb body 100UF) comprising a matrix of porous walls (e.g., porous walls 102) forming a plurality of channels (e.g., channels 106, 108), at least some of the plurality of channels being plugged to form inlet channels (e.g., inlet channels 106) and outlet channels (e.g., outlet channels 108), wherein some of the porous walls 102 are filtration walls (e.g., filtration walls 105) that separate inlet channels (e.g., inlet channels 106) from outlet channels (e.g., outlet channels 108) and at least some of the porous walls 102 are non-filtration walls (e.g., (e.g., non-filtration walls 305).

The method 700 further comprises, in block 704, subjecting the outlet channels (e.g., outlet channels 108) to a sacrificial filler (e.g., sacrificial filler 520) wherein the sacrificial filler at least partially fills some of the filtration walls (e.g., filtration walls 105.

The method 700 further comprises, in block 706, subjecting the outlet channels (e.g., outlet channels 108) to a catalyst-containing slurry (e.g., catalyst-containing slurry 624 such as a SCR catalyst-containing slurry) to form a filled and catalyst coated body (e.g., filled and catalyst coated body 100FC).

The method 700 further comprises, in block 708, calcining the filled and catalyst coated body (e.g., filled and catalyst coated body 100FC) to burn off the sacrificial filler (e.g., sacrificial filler) and form a catalyzed and plugged honeycomb body (e.g., catalyzed and plugged honeycomb body 100) with catalyst being preferentially loaded on the non-filtration walls (e.g., non-filtration walls 305). In some embodiments, the pre-filing of the porosity of the filtration walls 105 with sacrificial filler 520 and burning out thereof can result in the catalyst washcoat (and thus catalyst) being preferentially disposed on the non-filtration walls 305. For example, the present method 700 can provide a CR<0.2, wherein CR is a coating ratio defined as an average percentage loading of a washcoat containing the catalyst on and within the filtration walls 105 divided by an average percentage loading of the washcoat containing the catalyst on and within the non-filtration walls 305. The method 700 can provide CR that is lower than other methods providing a gas flow (e.g., air flow) from the inlet channels 106 to the outlet channels 108 such that at least some of the catalyst-containing slurry 624 on the filtration walls 105 is removed (blown off).

In the methods outlined above, the inlet channels 106 are substantially devoid of washcoat slurry 624 and thus substantially devoid of the catalyst-containing washcoat after calcining, and thus are devoid of catalyst. Further, the filtration walls 105 comprise a largely reduced amount of the washcoat, thus backpressure can be substantially reduced.

FIGS. 8-27 illustrate enlarged plan views showing an enlarged unit cell extracted from outlet end faces of several embodiments of coated honeycomb bodies 800, 900, 1000, and so on through 2700. The configuration of the unit cells shown can be populated all over the outlet end face 104. In the embodiment of FIG. 8, the filtration walls 105 form a pattern of equally sized squares of inlet channels 106 and outlet channels 108. The non-filtration walls 305 connect across opposing corners of the filtration walls 105 defining an outlet channel 108 having an x-shaped configuration of non-filtration walls 305 therein. Other configurations of non-filtration walls 305 described herein can be used. As can be seen in FIGS. 8-27, no non-filtration walls are provided in the inlet channels 106. The washcoat 425 is preferentially located and applied to the non-filtration walls 305. A small amount of the washcoat 425 may remain in or on the filtration walls 105, but to a lesser average weight extent (loading) than on the non-filtration walls 305. For example, the coating ratio CR may be less than 0.2.

In this FIG. 8 embodiment, there are the same numbers of outlet channels 108 as inlet channels 106. However, in this embodiment, due to the inclusion of the non-filtration walls 305, the total surface area of the outlet channels 108 is greater than a total surface area of the inlet channels 106, and wherein the catalyst is preferentially located within the outlet channels 108. In particular, the washcoat 425 is preferentially disposed on the non-filtration walls 305.

FIG. 9 is an enlarged plan view showing an enlarged unit cell extracted from an outlet end face of a coated honeycomb body 900 comprising an “octa-square” configuration in which there are an array of both octagon and square channels. This configuration of unit cell can be populated over the entire outlet end 104. On the inlet end 102, the inlet channels 106 are unplugged and the outlet channels 108 are plugged. The non-filtration walls 305 connect across opposing sides of the octagon in an x-shaped configuration. The washcoat 425 is preferentially disposed on non-filtration walls 305. In this embodiment, the outlet channels 108 are larger in cross-sectional area than the inlet channels 106. Further, the total surface area of the outlet channels 108 is greater than a total surface area of the inlet channels 106.

FIG. 10 is an enlarged plan view showing an enlarged portion extracted from an outlet end face of an alternate embodiment of a coated ceramic honeycomb body 1000 comprising a square-square configuration comprising corner radiusing. The non-filtration walls 305 connect across opposing sides of the octagon in an x-shaped configuration. However, other non-filtration wall configurations described herein can be used. The washcoat 425 is preferentially disposed on the non-filtration walls 305. In this embodiment, the outlet channels 108 are larger in cross-sectional area than the inlet channels 106. Furthermore, the total surface area of the outlet channels 108 is greater than a total surface area of the inlet channels 106. In FIGS. 9 and 10, the area ratio of a cross-sectional area of an inlet channel 106 to a cross-sectional area of an outlet channel 108 can be between 0.6 and 0.9, for example. Other area ratios can be used.

FIG. 11 is an enlarged plan view showing an enlarged unit cell extracted from an outlet end face of a coated honeycomb body 1100 according to one embodiment. In this embodiment, the outlet channels 108 are square and the inlet channels 106 are rectangles. The non-filtration walls 305 connect across opposing sides (e.g., midpoints) of the filtration walls 105 in a cross-shaped configuration. However, other filtration wall configurations described herein could be used. The washcoat 425 is preferentially applied to and disposed on the non-filtration walls 305. In this embodiment, there are more outlet channels 108 than inlet channels 106. The central outlet channel 108L of the unit cell comprising the non-filtration walls 305 is larger is cross-sectional area than the smaller outlet channels 108S in the corner of the unit cell that are devoid of non-filtration walls. The inlet channels 106 are also devoid of non-filtration walls. Thus, in this embodiment, some outlet channels 108 (e.g., the larger outlet channels 108L) comprise filtration walls 305 and others do not. Further, the total surface area of the outlet channels 108 is greater than a total surface area of the inlet channels 106.

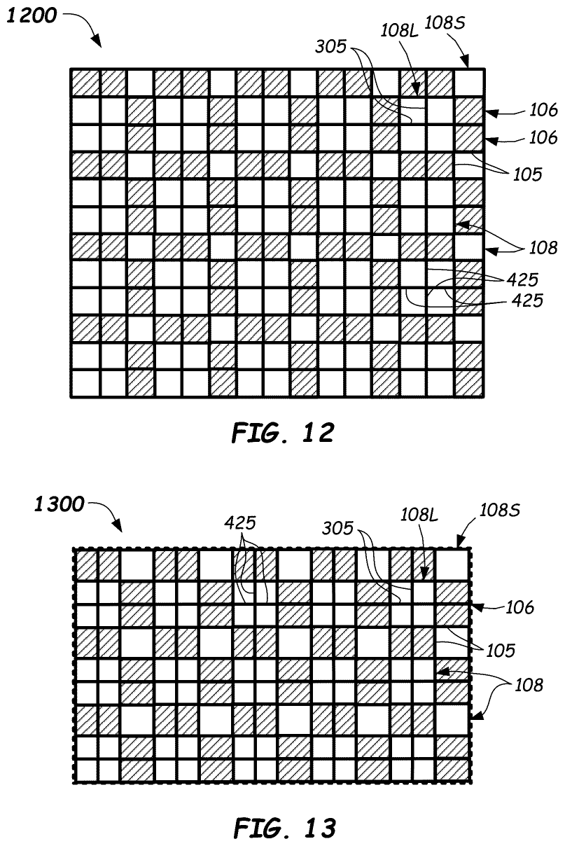

FIG. 12 is an enlarged plan view showing an enlarged portion extracted from an outlet end face of the coated ceramic honeycomb body 1100. In this embodiment, the outlet channels 108 are shown as white squares and the inlet channels 106 are shown as hatched squares. The non-filtration walls 305 connect to corners of the filtration walls 105 and are arranged in a cross-shaped configuration. The washcoat is preferentially located and disposed on the non-filtration walls 305. Further, FIG. 12 illustrates that some of the porous walls are filtration walls 105 that separate inlet channels 106 from outlet channels 108 and some of the porous walls are non-filtration walls 305 that separate and subdivide outlet channels 108. This embodiment comprises smaller inlet channels 106 and a combination of some larger outlet channels 108L and some smaller outlet channels 108S, wherein the smaller square-shaped inlet channels 106 being smaller is cross-sectional area than the larger square-shaped outlet channels 108L. Thus, in this embodiment, some of the outlet channels 108L are larger in cross-sectional area than at least some of the inlet channels 106 and the larger outlet channels 108L comprise non-filtration walls that further comprise a higher average loading, by weight, of catalyst-containing washcoat 425 (preferentially located coating) than do the filtration walls 105.

Thus, in the embodiment of FIG. 12, a honeycomb structure 1200 comprising a matrix of intersecting porous walls forming a plurality of axially extending channels is provided. At least some of the plurality of axially extending channels being plugged on an outlet end to form inlet channels 106 and plugged on an inlet end to form outlet channels 108, and wherein some of the outlet channels 108L are larger in cross-sectional area than at least some of the inlet channels 106. Further, the larger outlet channels 108L comprise non-filtration walls 305, and a catalyst-containing washcoat 425 is preferentially disposed on the non-filtration walls 305. “Preferentially disposed” as used herein means in or on the respective wall.

FIG. 13 is an enlarged plan view showing an enlarged portion extracted from an outlet end face of the coated ceramic honeycomb body 1300. In this embodiment, the outlet channels 108 are shown as white squares and the inlet channels 106 are shown as hatched rectangles. The non-filtration walls 305 connect to corners of the filtration walls 105 and are arranged in a cross-shaped configuration as shown. The washcoat 425 is preferentially applied to and disposed on the non-filtration walls 305.

Thus, in the embodiment of FIG. 13, a honeycomb structure 1300 comprising a matrix of intersecting porous walls forming a plurality of axially extending channels is provided. At least some of the plurality of axially extending channels comprise inlet channels 106 and outlet channels 108 as before. As in FIG. 12, some of the outlet channels 108L are larger in cross-sectional area than at least some of the inlet channels 106. Further, the larger outlet channels 108L comprise non-filtration walls 305 therein, and a catalyst-containing washcoat 425 is preferentially disposed on the non-filtration walls 305. In this embodiments, the inlet channels 106 are rectangular (non-square), and the outlet channels 108 comprise squares and combinations of larger outlet channels 108L and smaller outlet channels 108S, wherein the smaller outlet channels 108S are devoid of non-filtration walls and the larger outlet channels 108L comprise non-filtration walls 305.

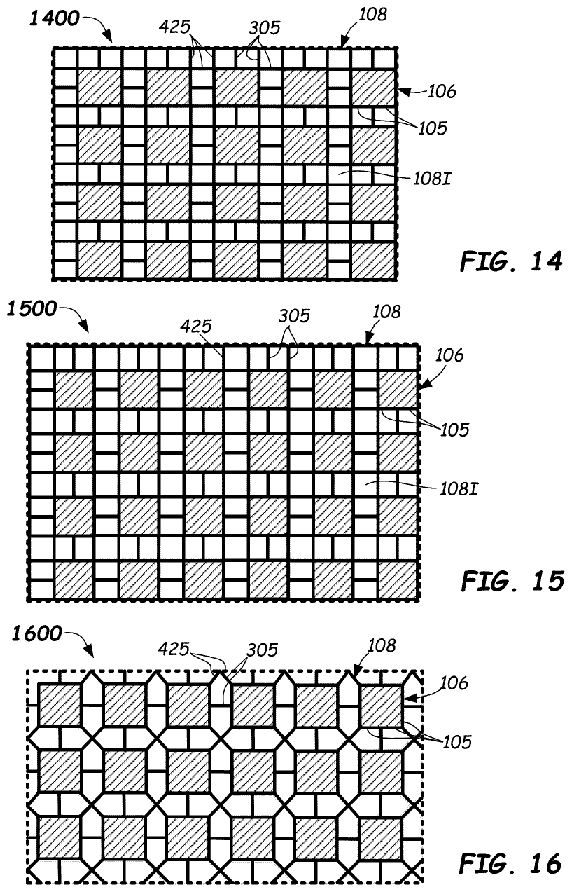

FIG. 14 is an enlarged plan view showing an enlarged portion extracted from an outlet end face of the coated ceramic honeycomb body 1400. In this embodiment, the outlet channels 108 are shown as smaller white squares and the inlet channels 106 are shown as larger hatched squares. Some of the non-filtration walls 305 connect to corners and others connected between midpoints of the filtration walls 105. The washcoat 425 is preferentially applied to and disposed on the non-filtration walls 305. In this embodiment, the number of outlet channels 108 is greater than a number of inlet channels 106 (8 outlets:1 inlet). Further, the inlet channels 106 have a larger cross-sectional area (4:1) as compared to the outlet channels 108. For each outlet channel 108 shown that are not at the intersections of the rows and columns of outlet channels 108, two filtration walls 105 and two non-filtration walls 305 are provided. At the intersections of the rows and columns, each of the outlet channels 108I comprise four non-filtration walls 305.

FIG. 15 is an enlarged plan view showing an enlarged portion of an outlet end face of the coated ceramic honeycomb body 1500. In this embodiment, the outlet channels 108 are shown as smaller white rectangles and the inlet channels 106 are shown as larger hatched squares. Some of the non-filtration walls 305 connect to corners and others connected between midpoints of the filtration walls 105. The washcoat 425 is preferentially applied to and disposed on the non-filtration walls 305. In this embodiment, the number of outlet channels 108 is greater than a number of inlet channels 106 (8 outlets:1 inlet). Further, each inlet channel 106 has a larger cross-sectional area as compared to the cross-sectional area of each of the outlet channels 108. However, the total cross-sectional area of the inlet channels 106 is less than a total cross-sectional area of the outlet channels 108. For each outlet channel 108 shown that are not at the intersections of the rows and columns of outlet channels, two filtration walls 105 and two non-filtration walls 305 are provided. At the intersections of the rows and columns, the outlet channels 108I have four non-filtration walls. Outlet channels 108 can comprise combinations of squares and rectangular non-squares.

FIG. 16 illustrates an enlarged plan view showing an enlarged part of an outlet end face of the coated ceramic honeycomb body 1600. In this embodiment, the outlet channels 108 are shown in white and the inlet channels 106 are shown as hatched squares. Some of the non-filtration walls 305 connect to corners and others connect between midpoints of the filtration walls 105. In this embodiment, the number of outlet channels 108 is greater than a number of inlet channels 106 (6 outlets:1 inlet). Further, each inlet channel 106 has a larger cross-sectional area as compared to the cross-sectional area of each of the outlet channels 108. However, the total cross-sectional area of the inlet channels 106 is less than a total cross-sectional area of the outlet channels 108. Further, the total surface area of the outlet channels 108 is greater than a total surface area of the inlet channels 106, and wherein a catalyst is preferentially located within the outlet channels. In particular, the washcoat 425 is preferentially applied to and disposed on the non-filtration walls 305. Outlet channels 108 comprise irregular pentagons comprising a shape of a baseball home plate.

FIG. 17 is an enlarged plan view showing an enlarged portion of an outlet end face of the coated ceramic honeycomb body 1700. In this embodiment, the outlet channels 108 are shown as white triangles and the inlet channels are shown as hatched triangles. As shown, there is one outlet channel 108 for every one inlet channel 106. The non-filtration walls 305 connect across opposing midpoints of the filtration walls in a y-shape configuration. In this embodiment, the number of outlet channels 108 is the same as the number of inlet channels 106 (a ratio of 1 outlet to 1 inlet). However, the total surface area of the outlet channels 108 is greater than a total surface area of the inlet channels 106. Further, the catalyst is preferentially located within the outlet channels 108. In particular, the washcoat 425 is preferentially applied to and disposed on the non-filtration walls 305. Outlet subchannels within the outlet channels 108 comprise quadrilaterals that are rhombuses, with a shape of a diamond as shown. Other rhomboid shapes are possible via repositioning the non-filtration walls 305.

FIG. 18 is an enlarged plan view showing an enlarged portion of an outlet end face of the coated ceramic honeycomb body 1800. In this octa-square embodiment, the outlet channels 108 are shown in white and the inlet channels 106 are shown as hatched with a modified plug pattern defining the inlet channels 106 and outlet channels 108. The non-filtration walls 305 connect to corners of the filtration walls 105. In this embodiment, the number of outlet channels 108 is greater than the number of inlet channels 106 (15 outlets to 9 inlets). Further, the total surface area of all the outlet channels 108 is greater than a total surface area of all the inlet channels 106. Moreover, the catalyst can be preferentially located within the outlet channels 108. In particular, the washcoat 425 can be preferentially applied to and disposed on the non-filtration walls 305.

FIG. 19 is an enlarged plan view showing an enlarged portion of an outlet end face of the coated ceramic honeycomb body 1900. In this embodiment, the outlet channels 108 are shown as white squares and the inlet channels 106 are shown as hatched squares. The outlet channels 108 can comprise non-filtration walls 305 extending into the outlet channels 108, like fins. The non-filtration walls 305 connect to corners of the filtration walls 105 and extend part way across the outlet channel 108 towards the opposing corner. In this embodiment, the number of outlet channels 108 is the same as the number of inlet channels 106 (1 outlet to 1 inlet). However, the total surface area of all the outlet channels 108 is greater than a total surface area of all the inlet channels 106. Moreover, the catalyst can be preferentially located within the outlet channels 108. In particular, the washcoat 425 can be preferentially applied to and disposed on the non-filtration walls 305 (fins).

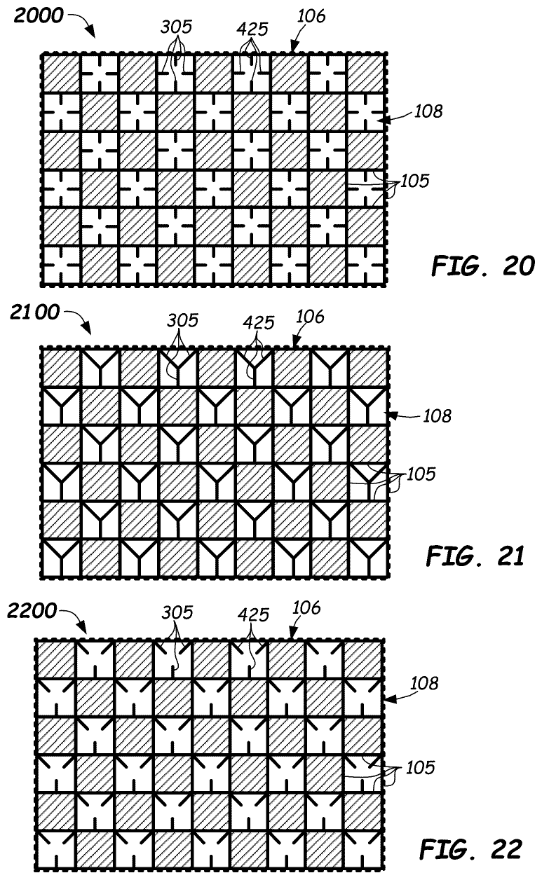

FIG. 20 is an enlarged plan view showing an enlarged portion of an outlet end face of the coated ceramic honeycomb body 2000. In this embodiment, the outlet channels 108 are shown as white squares and the inlet channels 106 are shown as hatched squares. The outlet channels 108 comprise non-filtration walls 305 extending into the outlet channels 108, like fins. The non-filtration walls 305 connect to midpoints of the filtration walls 105, such as between the corners thereof. In this embodiment, the number of outlet channels 108 is the same as the number of inlet channels 106 (1 outlet to 1 inlet). However, the total surface area of all the outlet channels 108 is greater than a total surface area of all the inlet channels 106. Moreover, the catalyst can be preferentially located within the outlet channels 108. In particular, the washcoat 425 can be preferentially applied to and disposed on the non-filtration walls 305 (fins).

FIG. 21 is an enlarged plan view showing an enlarged portion of an outlet end face of the coated ceramic honeycomb body 2100. In this embodiment, the outlet channels 108 are shown as white squares and the inlet channels 106 are shown as hatched squares. The outlet channels 108 comprise non-filtration walls 305 extending into and subdividing the outlet channels 108 into subchannels. The non-filtration walls 305 connect to a midpoint of one of the filtration walls 105, and the other two connect to corners thereof. Thus, the non-filtration walls 305 connect to the filtration walls 105 in a y-shape configuration. In this embodiment, the number of outlet channels 108 is the same as the number of inlet channels 106 (1 outlet to 1 inlet). However, the total surface area of all the outlet channels 108 is greater than a total surface area of all the inlet channels 106 due to the presence of the non-filtration walls. Moreover, the catalyst can be preferentially located within the outlet channels 108. In particular, the washcoat 425 can be preferentially applied to and disposed on the non-filtration walls 305.

FIG. 22 is an enlarged plan view showing an enlarged portion of an outlet end face of the coated ceramic honeycomb body 2200. In this embodiment, the outlet channels 108 are shown as white squares and the inlet channels 106 are shown as hatched squares. The outlet channels 108 comprise non-filtration walls 305 extending into the outlet channels 108, like fins. The non-filtration walls 305 connect to midpoints and corners of the filtration walls 105. In this embodiment, the number of outlet channels 108 is the same as the number of inlet channels 106 (1 outlet to 1 inlet). However, the total surface area of all the outlet channels 108 is greater than a total surface area of all the inlet channels 106. Moreover, the catalyst can be preferentially located within the outlet channels 108. In particular, the washcoat 425 can be preferentially applied to and disposed on the non-filtration walls 305 (fins).

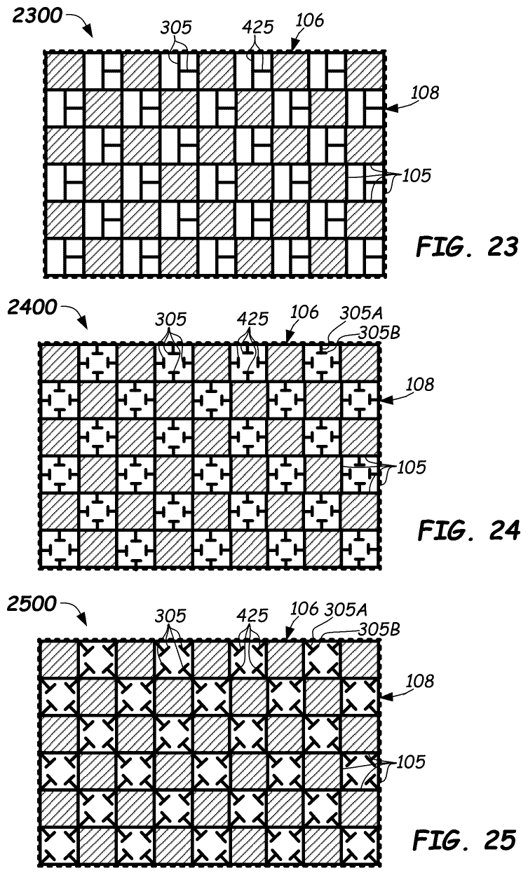

FIG. 23 is an enlarged plan view showing an enlarged portion of an outlet end face of the coated ceramic honeycomb body 2300. In this embodiment, the outlet channels 108 are shown as white squares and the inlet channels 106 are shown as hatched squares. The outlet channels 108 comprise non-filtration walls 305 extending into and subdividing the outlet channels 108 into two types of subchannels, such as rectangular (non-square) and square subchannels shown. The non-filtration walls 305 connect to a midpoint of the filtration walls 105. In this embodiment, the number of outlet channels 108 is the same as the number of inlet channels 106 (1 outlet to 1 inlet), but the total surface area of all the outlet channels 108 is greater than a total surface area of all the inlet channels 106 due to the presence of the non-filtration walls 305. Moreover, the catalyst can be preferentially located within the outlet channels 108. In particular, the washcoat 425 can be preferentially applied to and disposed on the non-filtration walls 305.

FIGS. 24-26 illustrate enlarged plan views showing enlarged portions of outlet end faces of a coated ceramic honeycomb body 2400, 2500, 2600, respectively. In these embodiments, the outlet channels 108 are shown as white squares and the inlet channels 106 are hatched squares. The outlet channels 108 comprise non-filtration walls 305 extending into the outlet channels 108, like fins. The non-filtration walls 305 connect to midpoints (FIG. 24) of the filtration walls 105, corners (FIG. 25) of the filtration walls 105, and combinations of midpoints and corners (FIG. 26) of the filtration walls 105. In this embodiment, the number of outlet channels 108 is the same as the number of inlet channels 106 (1 outlet to 1 inlet). However, in each embodiment, the total surface area of all the outlet channels 108 is much greater than a total surface area of all the inlet channels 106. Moreover, the catalyst can be preferentially located within the outlet channels 108. In particular, the washcoat 425 can be preferentially applied to and disposed on the non-filtration walls 305 (fins). In each embodiment, the non-filtration walls 305 comprise fins comprising a first fin portion 305A that connects to the filtration wall 105 (at midspan or at the corner) and a second fin portion 305B that couples to an end of the first fin portion 305A. The second fin portion 305B may be perpendicular to the first fin portion 305A or optionally at an angle thereto. Second fin portion substantially increase the surface area of the outlet channels 108. Other configurations of the second fin portion 305B can be used.

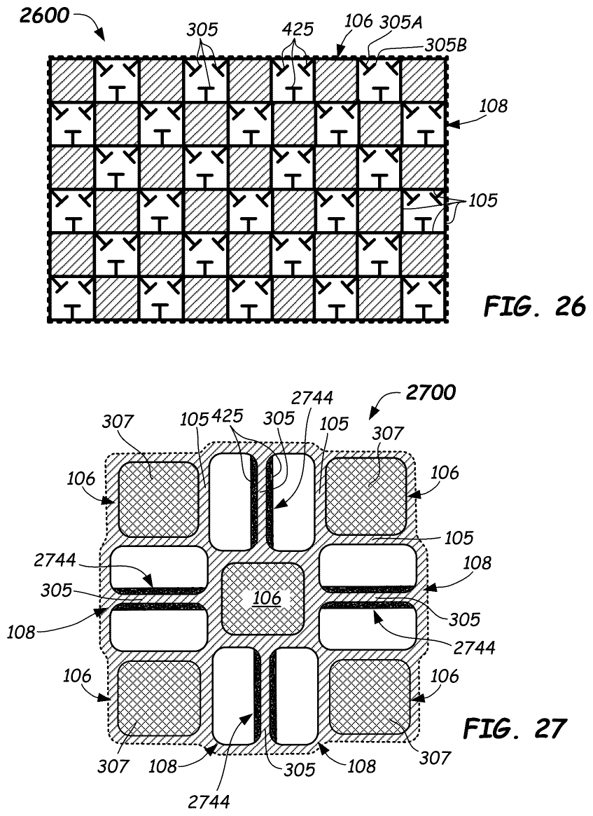

FIG. 27 illustrates enlarged plan view showing enlarged unit cell of an outlet end face of a coated ceramic honeycomb body 2700. In this embodiment, the outlet channels 108 are shown as white squares and the inlet channels 106 are hatched squares. The corners of the channels are provided with a suitable radius (or fillet). The outlet channels 108 comprise non-filtration walls 305 that are provided in the form of a single wall. However, other configurations may be used. The non-filtration walls 305 connect to midpoints of the filtration walls 105.

In this embodiment, the number of outlet channels 108 is the same as the number of inlet channels 106 (1 outlet to 1 inlet) for the honeycomb body when fully populated with like units cells. However, in each embodiment, the total surface area of all the outlet channels 108 is greater than a total surface area of all the inlet channels 106 because the outlet channels 108 are larger in cross sectional area and further because the outlet channels 108 comprise one or more non-filtration walls 305 therein. Moreover, the catalyst can be preferentially located within the outlet channels 108. In particular, the washcoat 425 can be preferentially applied to and disposed on the non-filtration walls 305.

In the embodiment of coated honeycomb body 2700 shown, the honeycomb structure comprises a matrix of intersecting porous walls forming a plurality of axially-extending channels, at least some of the plurality of axially-extending channels are plugged with plugs 307 on the outlet end 104 to form inlet channels 106 and plugged on an inlet end 102 to form outlet channels 108, wherein at least some of the outlet channels 108 (all as shown) contain a filler material 2744 and a catalyst (e.g., a selective catalyst reduction catalyst) is preferentially located within the outlet channels 108 and also preferentially disposed on the non-filtration walls 305 and on and in the filler material 2744. Thus, the filler material 2744 has a higher wt % loading of catalyst than do the filtration walls 105.

One example of a filler material 2744 may be a washcoat that exhibits a relatively high porosity. The slurry used to form the filler material 2744 can contain the desired catalyst or catalysts (e.g., an SCR catalyst, SOx, or three-way catalyst) and a suitable amount of a pore former. The slurry can be applied to the filtration walls 105 and non-filtration walls 305 in the outlet channels 108 by the coating methods described herein. After coating, a slurry removal method is performed on the wet-coated honeycomb body. Thereafter, the slurry comprising the pore former that is preferentially disposed on the non-filtration wall 305 can be calcined. The calcining temperatures for the coated honeycomb bodies can be from 300° C. and 600° C., for example. This calcining burns out the pore former and produces the filler material 2744 comprising catalyst in the outlet channels 108 and on the non-filtration wall 305 that is highly porous.

The pore former can be any suitable organic material such as hollow polymer microspheres, starch particles (e.g., corn, potato, pea, or other starches), carbon, and the like, that upon burning will produce open and interconnected porosity in the filler material 2744. The pore former can have a median particle diameter D₅₀ of between 1 μm and 50 μm, for example. The burnout during calcination can be conducted slowly enough, in an oxygen-controlled environment, or both, to avoid cracking of the coated honeycomb body 2700. The filler material 2744 in the outlet channels 108 can comprise a high amount of porosity, such as above 40% and the catalyst is contained in the filler material 2744.

The current disclosure relates to a ceramic honeycomb bodies for use as a catalyst support with plugged channels comprising inlet channels 106 and outlet channels 108. Inlet channels 106 are open on the inlet end face and plugged on the outlet end face and are devoid of non-filtration walls. Outlet channels are open on the outlet end face and plugged on the inlet end face. The ceramic honeycomb body is characterized by structural features, possibly in combination with microstructural features. First, the ceramic honeycomb body can have a higher total geometric surface area in the outlet channels 108 as compared with the inlet channels 106. In one embodiment, the higher total surface area may be accomplished by having a larger number of outlet channels 108 relative to inlet channels 106. In this embodiment, some of the porous ceramic walls that define the boundaries of the outlet channels 108 comprise filtration walls 105 (which separate inlet channels from outlet channels), and some of the porous ceramic walls which make up the outlet channels 108 can be non-filtration walls (which separate neighboring outlet channels 108 or subdivide outlet channels 108).

In embodiments, the increased total surface area in the outlet channels may be accomplished by the incorporation of non-filtration walls, like fins, that extend into the outlet channel 108 within the outlet channels and that increase the surface area relative to the inlet channels 106, wherein the fins comprise a terminal end or ends within the outlet channel 108.

Further, the disclosure is characterized by a catalyst (e.g., a SCR catalyst or other catalyst) located preferentially within the outlet channels 108 and preferably, the catalyst is loaded preferentially on or within the pore structure of the non-filtration walls 305 within the outlet channels 108. In some embodiments, the porosity is controlled to be in one of two categories. “Category 1” is a low to intermediate porosity body having porosity in the range from 40%-60% porosity with median pore diameter from 8 μm to 16 μm. This pore structure is intended to support on-wall catalyst loading. On-wall catalyst loading has the advantages of improved catalytic activity relative to in-wall loading (and therefore can support reduced catalyst loads), and additionally, catalyst preferentially located on the non-filtration walls 305 allows for better separation from the soot on the inlet channels 106 due to the reduced catalyst in the filtration walls 105. This allows for better passive regeneration of the soot in the inlet channels 108 since there is no competition with the catalyst for NO₂. Low porosity also enables thinner wall geometries at a similar bulk density and therefore designs having higher open frontal area than conventional designs are possible. The higher open frontal area (OFA) can be provided due to the offsetting effect of less on-wall catalyst on the filtration walls 105.

“Category 2” is a high porosity body that can support in-wall catalyst loading or a combination of in-wall and on-wall catalyst loading. The porosity, in this case, can range from 55% to 75% and the median pore diameter can be between about 14 μm and 30 μm. In some embodiments, the porous walls comprise an average bulk porosity in a range from 60% to 70% and a median pore diameter of from 14 μm to 25 μm. This porosity and median pore diameter is particularly effective as a catalyst support for SCR catalysts when the channel density is between 250 (23 cells/cm²) and 450 cpsi (68 cells/cm²) and transverse wall thickness is between even between 0.006 (0.15 mm) to 0.014 inch (0.36 mm).

The coarser pore structure may enable distribution of catalyst within the wall porosity of the non-filtration walls 305. The advantage of in-wall catalyst loading is that it limits the reduction in hydraulic diameter of the channels (e.g., outlet channels 108) where washcoat material is preferentially loaded. Since the catalyst can be predominantly in the non-filtration wall 305, it may not appreciably constrict the outlet channels 108 and therefore the outlet channels 108 avoid a reduction in hydraulic diameter that can occur with on-wall coating.

In each of the embodiments described herein, the honeycomb body 100-2700 may comprise a porous ceramic material such as cordierite, aluminum titanate, mullite, silicon carbide, zirconia, and the like, and combinations thereof. Other suitable porous ceramic or other porous materials can be used. The transverse wall thickness of the filtration walls 105 can range from about 0.006 inch (0.15 mm) to 0.020 inch (0.51 mm), or even between 0.006 (0.15 mm) to 0.014 inch (0.36 mm), for example. The non-filtration walls 305 can be thinner or the same thickness as the filtration walls 105. The channel density of the honeycomb bodies 100-2700 can range from about 200 cpsi (31 cells/cm²) to 600 cpsi (91 cells/cm²), and from 250 (23 cells/cm²) and 450 cpsi (68 cells/cm²) in some further embodiments, for example.

The unique combination of both filtration walls 105 and non-filtration walls 305 in the outlet channels 108 enables the preferential coating of the non-filtration walls 305 during the washcoat process. The use of non-filtration walls 305 in the outlet channels 108 and coating methods described herein limits the concentration of catalyst in the filtration walls 105 to a substantially level lower than in a conventional SCR filter, thus providing the same catalytic activity, but with lower backpressure. In each embodiment, the catalyst being preferentially disposed comprises CR<0.2 wherein CR is a coating ratio defined as an average % loading of a washcoat containing the catalyst on and within the filtration walls 105 divided by an average % loading of the washcoat containing the catalyst on and within the non-filtration walls 305.

In addition, methods for coating the ceramic honeycomb bodies are provided. One coating method involves the introduction of the catalyst-containing slurry 524 into the outlet channels 108 after filling the filtration walls 105 with the sacrificial filler 520 and subsequently burning off the sacrificial filler 520. This process substantially reduces the catalyst weight loading in and on the filtration walls 105 relative to the non-filtration walls 305, as the pores already filled with the sacrificial filler 520 in the filtration walls 105 cannot accept any appreciable amount of washcoat 425.

While embodiments of this disclosure have been disclosed in example forms, many modifications, additions, and deletions can be made therein without departing from the scope of this disclosure, as set forth in the claims and their equivalents.

What is claimed is:

1. A method of coating a honeycomb body with a catalyst, the honeycomb body comprising a matrix of porous walls forming a plurality of channels, at least some of the plurality of channels plugged at an outlet end of the honeycomb body to form inlet channels and at least some of the plurality of channels plugged at an inlet end of the honeycomb body to form outlet channels, the method comprising:
exposing the outlet channels of the honeycomb body to a sacrificial filler through an outlet end of the honeycomb body, wherein at least some of the porous walls that separate inlet channels from outlet channels are filtration walls and at least some of the porous walls that do not separate inlet channels from outlet channels are non-filtration walls, and wherein the sacrificial filler is deposited in pores of at least some of the filtration walls of the outlet channels;
subjecting the outlet channels to a catalyst-containing slurry to form a catalyst coated body by depositing particles of the catalyst-containing slurry on or in the non-filtration walls; and
removing the sacrificial filler to preferentially load catalyst on or in the non-filtration walls.

2. The method of claim 1, wherein the catalyst is preferentially loaded on the non-filtration walls to result in a coating ratio CR<0.2, wherein the coating ratio CR is defined as an average percent loading of a washcoat containing the catalyst on and within the filtration walls divided by an average percent loading of the washcoat containing the catalyst on and within the non-filtration walls.

3. A method of catalyst coating a plugged honeycomb body comprising a honeycomb structure of inlet channels and outlet channels, comprising:
subjecting the outlet channels, filtration walls separating the outlet channels from the inlet channels, and non-filtration walls located within the outlet channels, to a sacrificial filler, the sacrificial filler preferentially infiltrating pores of the filtration walls; and
subjecting the outlet channels and the non-filtration walls to a catalyst-containing slurry, the sacrificial filler in the pores of the filtration walls causing preferential loading of the catalyst-containing slurry on the non-filtration walls.

4. The method of claim 3, further comprising heating the honeycomb body to burn off the sacrificial filler.

5. The method of claim 4, wherein the heating is conducted at equal to or greater than 600° C.

6. The method of claim 3, wherein the sacrificial filler comprises carbonaceous soot.

7. The method of claim 3, wherein an average particle size of the sacrificial filler is less than a median pore size of the filtration wall pores.

8. The method of claim 3, wherein an average particle size of the sacrificial filler is in a range from 0.005 μm to 300 μm and a median pore size of the filtration wall pores is in a range from 5 μm to 30 μm.

9. The method of claim 3, comprising monitoring a backpressure of the honeycomb structure as the outlet channels are subjected to the sacrificial filler to gauge a degree of fill of the filtration walls with the sacrificial filler.

10. A method of coating a honeycomb body with a catalyst, comprising
exposing a honeycomb body to a sacrificial filler material, the honeycomb body comprising an inlet end, an outlet end, and a matrix of porous walls extending therebetween, the matric of porous walls comprising a plurality of porous filter walls forming a plurality of channels, at least some of the plurality of channels plugged proximate the outlet end to form inlet channels and at least some of the plurality of channels plugged proximate the inlet end to form outlet channels, the plurality of filter walls separating inlet channels from outlet channels, and a plurality of non-filter walls disposed in the outlet channels and extending between the filter walls forming the outlet channels, the exposing comprising directing the sacrificial filler material into the outlet channels through the outlet end, the sacrificial filler material depositing in pores of the porous filtration walls;
directing a catalyst-containing slurry into the outlet channels, the catalyst-containing slurry depositing on or in the non-filtration walls; and
removing the sacrificial filler to preferentially load catalyst on or in the non-filtration walls.

11. The method of claim 10, wherein the sacrificial filler comprises carbon.

12. The method of claim 10, wherein the removing comprises heating the honeycomb body to a temperature sufficient to burn off the sacrificial filler and calcine the catalyst-containing slurry to form a calcined washcoat.

13. The method of claim 12, wherein the heating is conducted at a temperature in a range from 300° C. to 1,000° C. for a time from 30 minutes to 5 hours.

14. The method of claim 10, wherein the catalyst comprises an SCR catalyst.

15. The method of claim 10, wherein the catalyst comprises at least one of platinum, palladium, rhodium, ruthenium, or iridium.

16. The method of claim 10, wherein the catalyst-containing slurry comprises oxides or aluminum oxides of at least one of lithium, magnesium, calcium, manganese, iron, cobalt, nickel, copper, zinc, or silver.

17. The method of claim 12, wherein the catalyst is an SCR catalyst, and a loading of the calcined washcoat on the non-filtration walls is in a range from 20 g/L to 250 g/L.

18. The method of claim 10, further comprising drying the honeycomb body at a temperature in a range from 50° C. to 150° C.
